(19) United States
(12) Patent Application Publication
(10) Pub. No.: US 2004/0093562 A1
(43) Pub. Date: May 13, 2004

(54) System and method for a hierarchical browser

(76) Inventors: Donato S. Diorio, Hartland, WI (US); Igor S. Petrenko, Waukesha, WI (US); Kevin E. Schuetz, Middleton, WI (US)

Correspondence Address: JEFFREY FURR, 253 N. MAIN STREET, JOHNSTOWN, OH, 43031, US

(21) Appl. No.: 10/647,767

(22) Filed: Aug. 25, 2003

Related U.S. Application Data
(60) Provisional application No. 60/319,489, filed on Aug. 23, 2002.

(51) Int. Cl. G06F 17/00

(52) U.S. Cl. 715/513

(57) ABSTRACT

The current invention is a HHierarchicalTab (HHTab browser interface. The iinterfaceis enhanced with features that allow the tracking, nnavigation and management of hierarchical relationships of currently open web pages. Having pages currently open is a key to the innovation of the current invention. The current invention tracks the current state and iinterrelationshipbetween open web pages. The current invention allows for a child and parent relationship. Thie current invention allows for individual HTab nodes to exist in a orizontalcollapsed state. while maintaining parent child relationships The current invention creates a bookmark system capable of preserving hierarchies

### CROSS REFERENCE TO RELATED APPLICATIONS

This application claims the Priority Date of Provisional Application 60/319,489 filed Aug. 23, 2002.

### BACKGROUND OF INVENTION

1. Field of the Invention

This invention relates to the art of a Graphical user interface (GUI) to display, organize, and manage hierarchically linked web pages currently open within a web browser.

2. Description of Prior Art

Hierarchical Tab (HTab): Graphical user interface (GUI) to display, organize, and manage hierarchically linked web pages currently open within a web browser. GUI's for Internet Browsers have undergone little change since the first version of Netscape. The basic functionality required for a browser application is a browsing window for viewing HTML documents, an input location to type a URL, and buttons to control browser navigation (Back, Forward, Stop, Refresh, and Home). In recent years, tabbed browsers have become available. These browsers use notebook style tabs that can be seen in any number of programs such as Microsoft Excel. With these browsers, multiple overlapped pages can be loaded into the browser at the same time, one page displaying at a time, depending upon the active tab. Tabbed browsers are much more user friendly. Netscape has recently introduced tabs into its GUI.

The problem with existing tabbed browsers is that they have added multiple pages that duplicate the old way of browsing. They do not take into account the interrelationship between multiple open browser pages. Browsing is an activity that is done in a hierarchical pattern. Current browser GUI's do not track the current hierarchy that exists within the state of open browser pages. It could be argued that the standard navigation buttons can track hierarchy. That argument is flawed. Navigation buttons can only trace one linear non-branching path within the browsing hierarchy tree. A hierarchy can encompass multiple paths traversed, with multiple branches stemming from any one point.

Henceforth, “the system” will be used interchangeably with “HTab”. “The System” refers to the entire browser application which includes the HTab as well as other components that are used to interface with the HTab.

Within any browser, when a user clicks on web page hyperlink, the current page is replaced with the new page that is loaded. The System works the same. In addition, browsers usually have a method of opening a hyperlink in a new page. This is accomplished in response to a mouse click and one additional user input, such as pressing the SHIFT key. With single-paged browsers, such as Internet Explorer 5.5, the open in new page function causes a new copy of the application to be instantiated for displaying the new page. In tabbed browsers, the new page is opened within the same application, and a new tab is created. In the system, an additional HTab is opened with the new web page in it, and a minus icon is added to the HTab that represents the page that spawned the link. In the system 1, the newly created link is treated as a child link. HTabs can have any number of child links.

An additional shortcoming of prior browser GUI's is the inability to make efficient use of screen space to display a large number of opened web pages. Tabbed browsers do not solve this problem; a set amount of horizontal space is required for each additional open tab.

The need for a better method for Internet Browsing that allows for hierarchical browsing and makes efficient use of screen space shows that there is still room for improvement within the art.

### SUMMARY OF INVENTION

The object of the present invention is to provide a method for hierarchical browsing by a user 10. An additional objective is to make efficient use of screen space. An additional objective is to create a bookmark system capable of preserving hierarchies.

The current invention is a Hierarchical Tab (HTab) browser interface. The interface is enhanced with features that allow the tracking, navigation, and management of hierarchical relationships of currently open web pages. Having pages currently open is a key to the innovation of the current invention. Prior art does exist that tracks the history of web pages that were open. The current invention tracks the current state and interrelationship between open web pages and is not concerned with the history.

The current invention has the ability to change to a horizontally collapsed state. The collapsed state is in response to a user 10 double clicking the mouse on an HTab. A second double click of the mouse returns the HTab to its standard expanded state.

The current invention may have child pages that have an optional icon in the lower right of the HTab component. The icon is akin to how a plus or minus icon acts in a standard tree user interface; pressing the minus icon will collapse the children and pressing the plus icon will expand the tree. HTabs can be collapsed by two methods; individually, as previously described, and collectively. A collective collapse is performed by pressing the minus icon in the parent HTab. This action causes all children of the parent HTab to collapse, while the parent HTab remains in the expanded state. The ability to collapse a group of child HTabs allows significant improvement in working with limited screen space.

In the collapse state, an HTab does not have enough space on it to display a web page label. The identification of the contents of the collapsed HTab can be identified by simple methods such as showing a hint with the full page title when the mouse moves over the HTab.

Terminology: GUI: Graphical User Interface

HTML: Hypertext Markup Language

URL: Uniform Resource Locator.

Tabbed Browser: An Internet browser GUI that manages multiple open web pages. Each web page is represented by one tab. Only one page is visible at a time, depending on the currently selected tab.

Hierarchical Tab (HTab). A GUI component used to display, organize, and manage hierarchically linked web pages currently open within a web browser.

Open in New Page: In a tabbed browser, this function opens a new web page in its own browser window, separate from the browser page it was originally opened from. In a non-tabbed browser this function would open an entirely new copy of the browser program to display the new page.

Open in Existing Page: In either a tabbed or non-tabbed browser, this function causes the newly opened page to replace the current page.

Pop-ups: Web pages that when opened, overlay the current browser page. Pop-ups usually occupy only a portion of the available screen space.

Pop-unders: Pop-up web pages that are created behind the browser application and thus hidden.

Auto-refresh: Process of updating a currently loaded web page on a preset interval.

1^{st} Level Domain Name: The most base part of the domain name. Example: aa.com

2^{nd}Level Domain Name: Additional sub domain designation added to the front of a 1^{st} level domain name. Examples: www.aa.com, test.aa.com.

Page Icon: A common practice for web sites is to place a link in the homepage HTML file that links to an image which represents the site. Browsers navigating to the site then have a unique icon image that can be used to represent the site within the browser application.

Open Database connectivity (ODBC): A method within the Windows operating system that acts as a common handler for various databases. Each database vendor supplies a driver which allows Windows to use a common set of functions to control each database.

### BRIEF DESCRIPTION OF DRAWINGS

FIG. 1—Display a User interacting with the Internet.

FIG. 2—HTab shown as Tabs

FIG. 3—HTab shown as flat buttons

FIG. 4—HTab shown as buttons

FIG. 5—HTab with three open pages. Active web page is “Google”.

FIG. 6—Three child links opened from “Yahoo”(Auctions, Autos, Shopping)

FIG. 7—Child HTabs of “Yahoo” shown collapsed.

FIG. 8—HTabs before double click of mouse on “Google” HTab

FIG. 9—HTab after double click of mouse on “Google” HTab

FIG. 10—HTabs 4 levels deep.

FIG. 11—HTabs taking up all space horizontally.

FIG. 12—HTab control expanded vertically to accommodate an additionally opened web page.

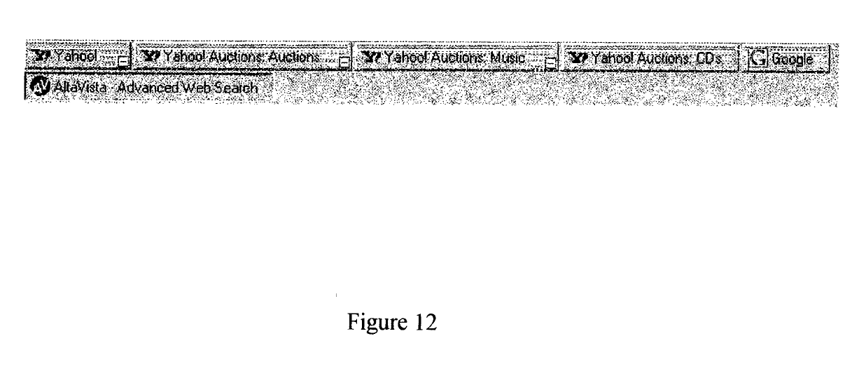

FIG. 13—Scroll buttons are added when allotted vertical space is exceeded.

FIG. 14—No HTab has mouse focus

FIG. 15—Yahoo HTab has mouse focus

FIG. 16—Yahoo HTab with 2 children, no mouse focus

FIG. 17—Yahoo HTab receives mouse focus

FIG. 18—URL address bar with current URL being http://www.yahoo.com

FIG. 19—Navigation bar with New Page and Close Page buttons.

FIG. 20—Context menu for HTabs

FIG. 21—3×3 HTML TABLE displayed within a web browser

FIG. 22—HTML TABLE with sample data

FIG. 23—HTML TABLE with sample data and highlighted text

FIG. 24—The System's Launch Manager

FIG. 25—Resulting HTabs after function “Launch all column links”

FIG. 26—User highlights one hyperlink from a list of returned search results

FIG. 27—“Launch links like this” results from example shown in FIG. 25

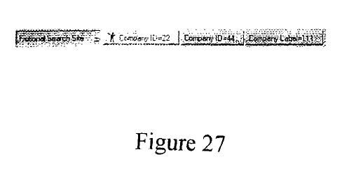

FIG. 28—X-Ray dialog box

FIG. 29—Results of 2^{nd} level domain X-Ray in HTabs

FIG. 30—Peel and Iterate dialog box

FIG. 31—Results of Peel and Iterate in HTabs

FIG. 32—Data builder form.

FIG. 33—Data builder export form.

FIG. 34—Login Wage Wizard form.

FIG. 35—Link properties of an HTab bookmark.

### DETAILED DESCRIPTION

The preferred embodiment of the invention is described below.

The current invention uses Internet communications tool, browser, ISP (Internet Service Providers), embedded web-site, URL, protocols and languages that are known to one skilled in the art and therefore not disclosed here in detail.

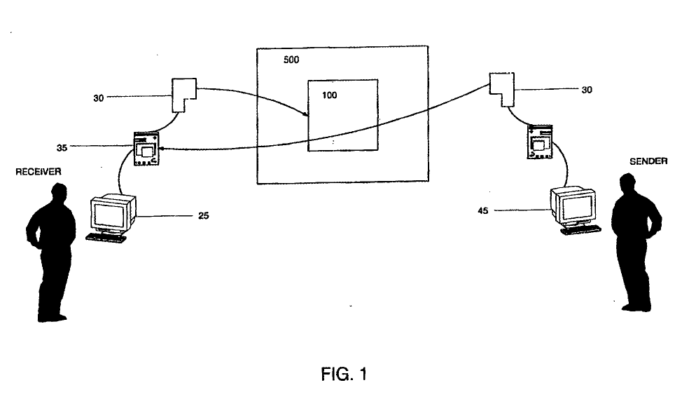

FIG. 1 illustrates a functional diagram of how a User 10 uses a computer 25 connected to the Internet 500. The computer 25 can be connected directly through a communication means such as a local Internet Service Provider, often referred to as ISPs, or through an on-line service provider like CompuServe, Prodigy, American Online, etc.

The Users 10 contacts the Internet 500 using an informational processing system capable of running an HTML compliant Web browser. A typical system that is used is a personal computer with an operating system such as Windows 95, 98 or ME or Linux, running a Web browser. The exact hardware configuration of computer used by the User 10 and the brand of operating system is unimportant to understand this present invention.

Those skilled in the art can conclude that any HTML (Hyper Text Markup Language) compatible Web browser is within the true spirit of this invention and the scope of the claims.

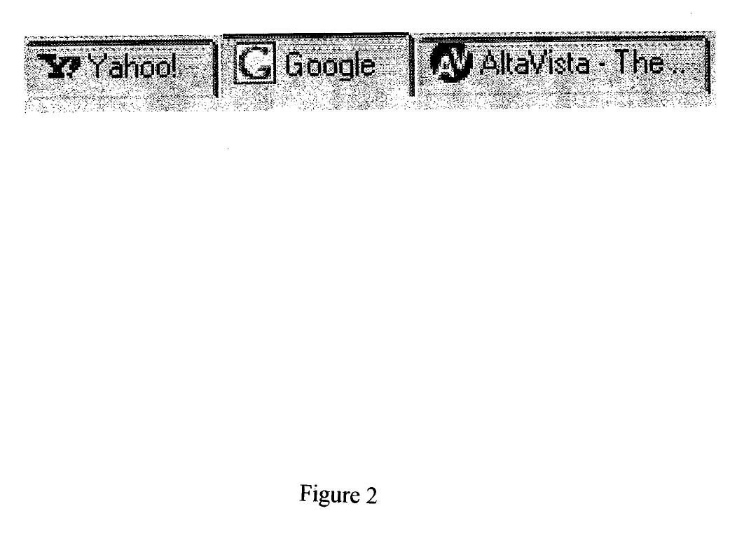

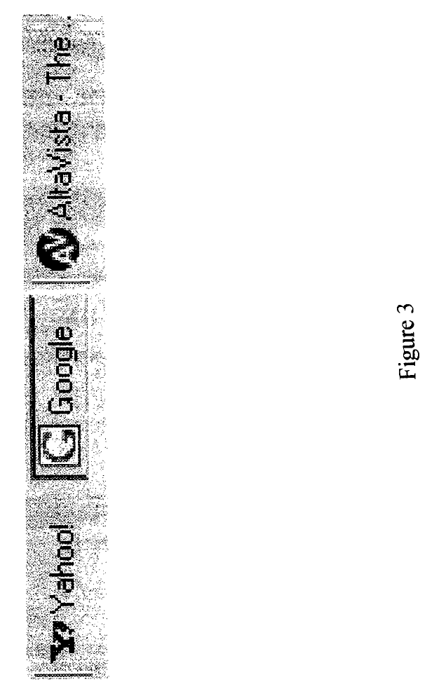

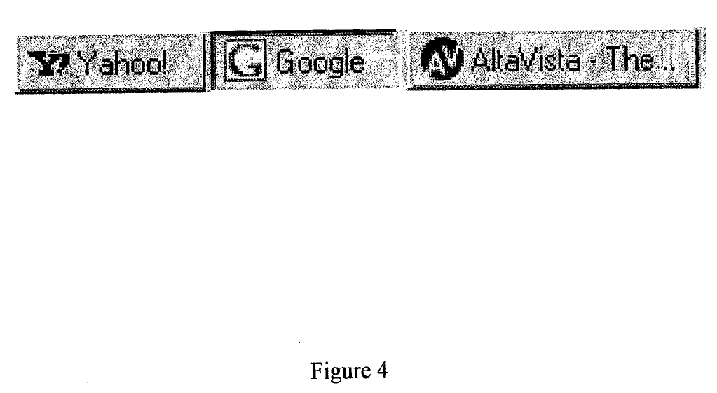

Each open web page in the system 1 is represented by an HTab. An HTab can be displayed in several standard forms found in many GUI's including Tabs, Flat Buttons and Standard Buttons (FIGS. 2, 3, 4). In FIG. 2, an HTab is displayed for each open web page (Yahoo, Google, and AltaVista). The middle tab (Google) represents the currently selected HTab.

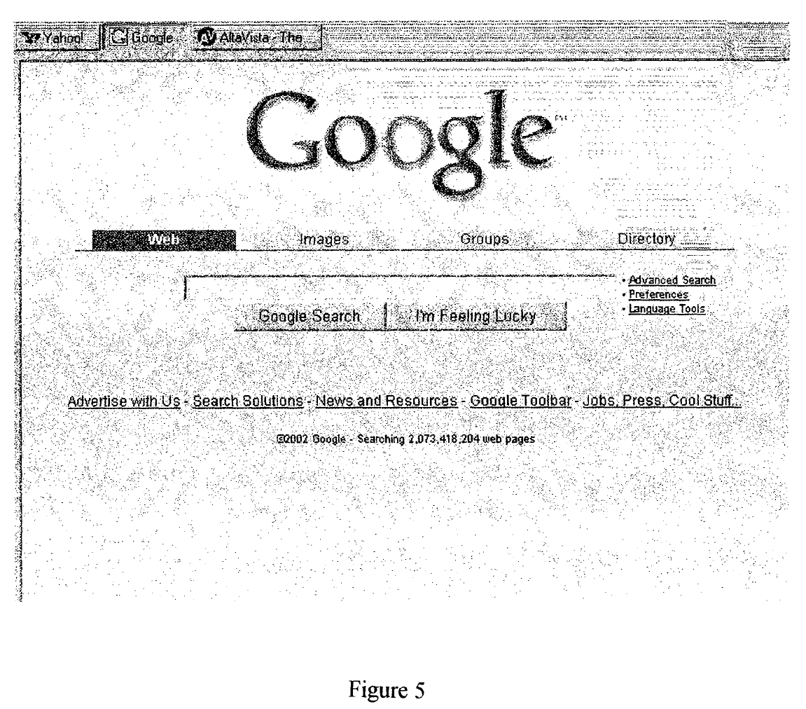

The currently selected HTab determines the page displayed by the system 1. In FIG. 5, open tabs from FIG. 2 are shown in addition to the actively displayed web page in the browser window. From this point forward, the actively displayed web page will be cut from the diagrams, and only the HTab portion will be displayed.

In the system 1, a mouse click on a hyperlink is treated the same as with existing web browsers; the hyperlink is followed and the current web page is replaced by the newly loaded page. Hyperlinks can also be opened in a new page. In most browsers, this is accomplished by pressing the SHIFT key while clicking on the hyperlink with the mouse. The System 1 opens a link in a new page in the same way. In addition to opening the new link, the system's 1 HTab GUI records the newly open page as a child HTab. Therefore, the hierarchical relationship between the original parent page (containing the hyperlink) and the child page is recorded.

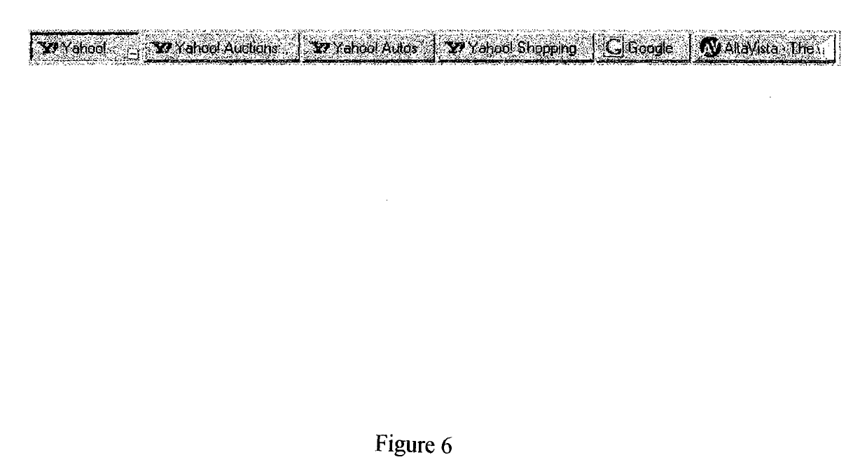

In FIG. 6, there are three open child links in the System 1 (Yahoo Auctions, Yahoo Autos, and Yahoo Shopping). These three pages are child links of the original Yahoo page. The child pages were created by pressing the SHIFT key while clicking on each link with the mouse. When an HTab becomes are parent, a minus icon was placed on the bottom right side of the parent HTab (YAHOO).

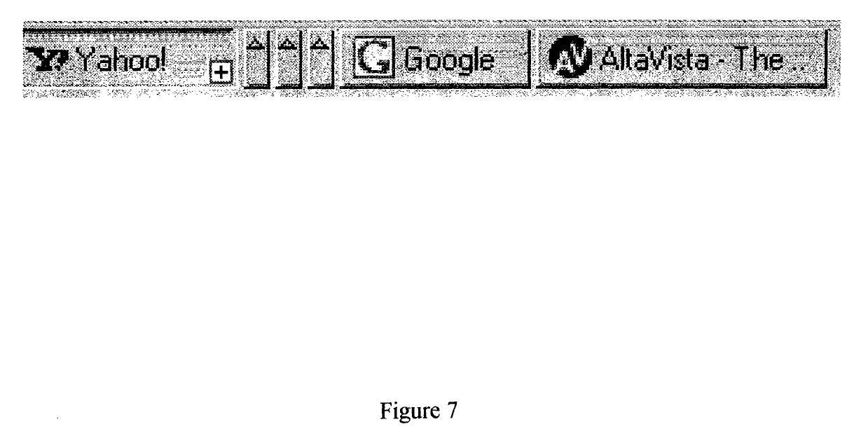

HTabs with linked child HTabs are identified by an additional graphic within the body of the parent HTab. The preferred location is the lower right section of the parent HTab. In FIG. 6 the collapse button is shown, in FIG. 7 the expand button is shown as a plus icon.

HTabs have 2 possible display states.

Expanded: The HTab is full size. An expanded HTab consists of an optional graphic icon (Page Icon) representative of the web page, and a text label representative of a web page title. See FIG. 6

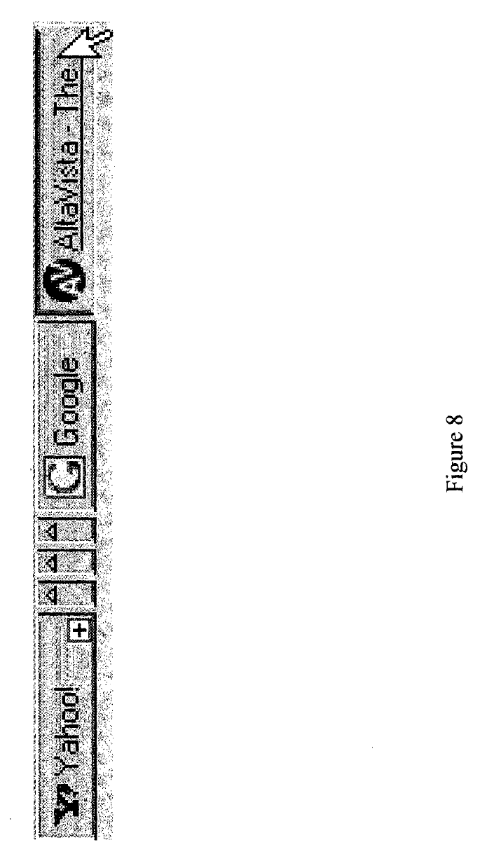

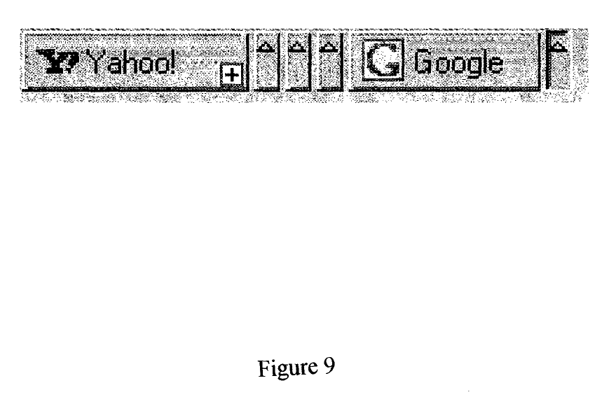

Collapsed: The HTab is reduced to a minimum width. A collapsed HTab maintains the minimum width needed to represent a page in the interface. The text label and Page Icon are absent. See FIG. 7 HTabs can be individually expanded or collapsed by double clicking the mouse on the tab (FIGS. 8 and 9). A parent HTab can have any number of child HTabs associated with it, the only limitation being the memory storage of the computer hardware. Implementations of programs using the HTab may choose to limit the maximum number of HTabs to a manageable number.

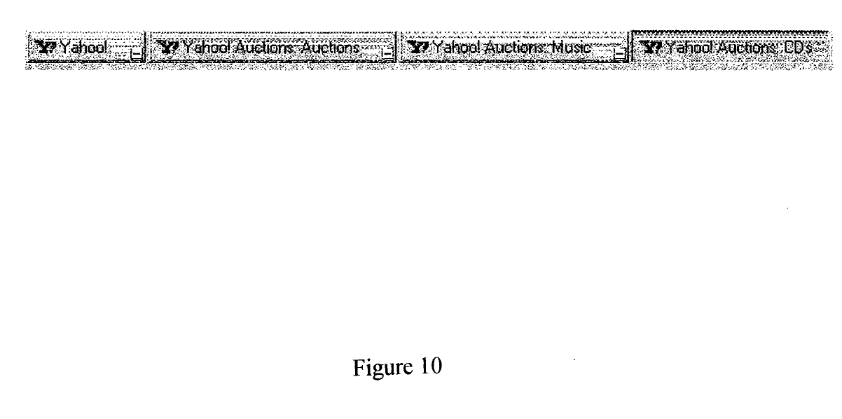

Groups of HTabs can be arranged from 1 to N depth, representing the parent-child hierarchical relationships between open web pages. In FIG. 10, the HTabs are shown four levels deep.

In FIG. 10, “Yahoo” is the parent of “Yahoo Auctions”, “Yahoo Auctions” is the parent of “Yahoo Auctions: Music” Yahoo Auctions: Music” is the parent of “Yahoo Auctions: CDs”.

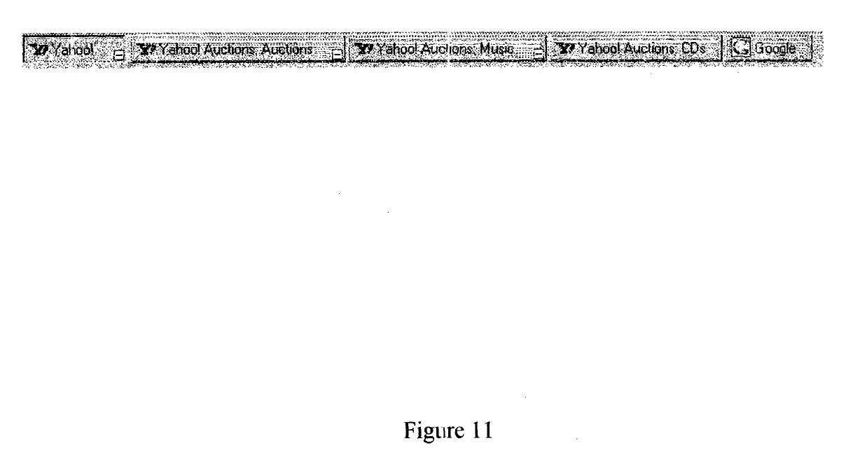

Each open web page is represented by an HTab and is arranged horizontally in rows. If additional HTabs are needed beyond the horizontal space allotted, additional rows are created to accommodate the added tabs. (See FIGS. 11 & 12) The HTab GUI maintains the organizational structure of all open web pages and the hierarchical relationships. Each open web page may or may not have children.

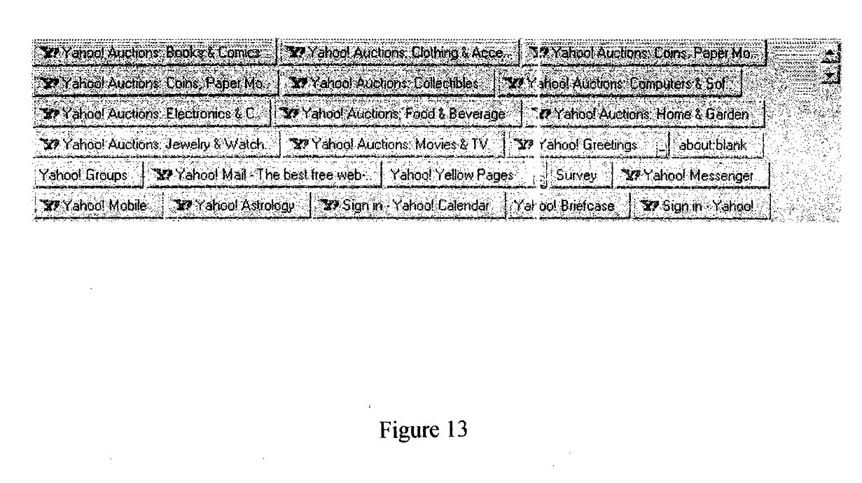

The programmer implementing the HTab may set a maximum vertical size limit for the HTabs. If the number of HTabs expands beyond the allotted vertical space, scroll up and scroll down arrows are added to the upper right of the control. The user 10 then has access to more HTabs than can visually fit in the allotted space. (See FIG. 13).

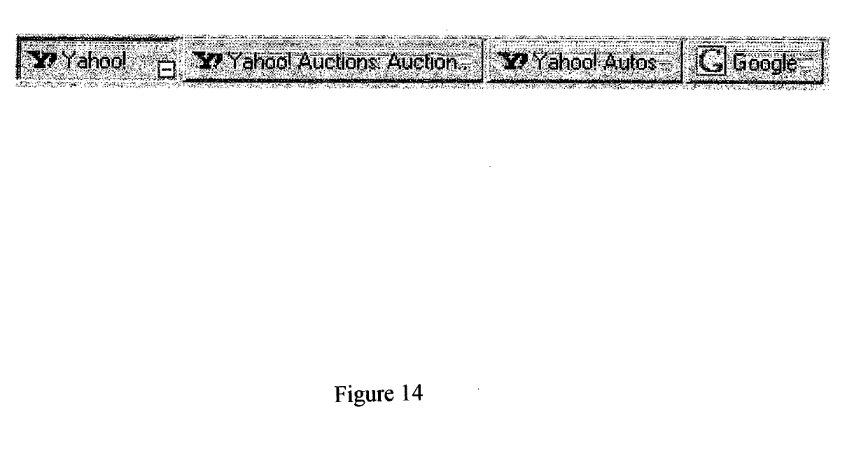

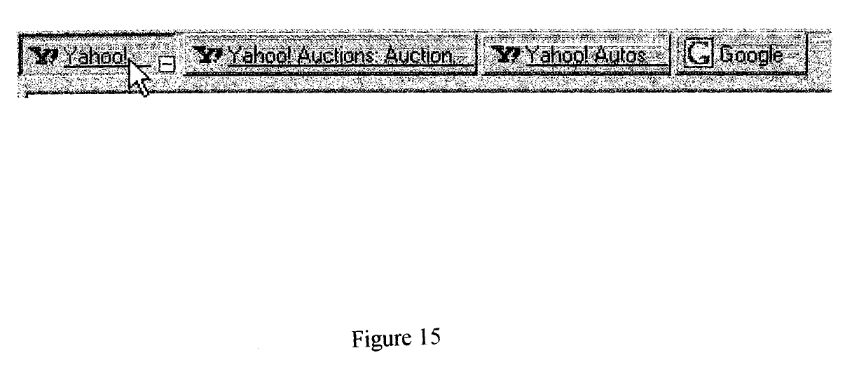

When there are many open HTabs, it could be confusing as to which HTabs are children. To make it visually easy to determine, child HTabs are underlined when the parent link receives focus from the mouse. In FIG. 14, no HTab has mouse focus. In FIG. 15, the HTab “Yahoo” is activated by the mouse and “Yahoo's” children (“Yahoo Auctions” and “Yahoo Autos”) are underlined.

When many HTabs are open within the Browser, the user 10 can save space by collapsing the children that are hierarchically linked to a parent HTab. This is accomplished by a single mouse button click on the plus icon in the parent HTab. This action changes the minus icon to a plus icon and the children of the parent are changed to the collapsed state.

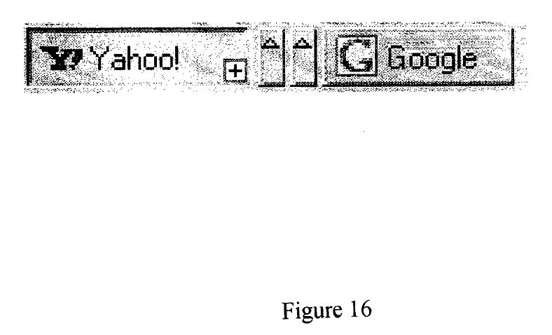

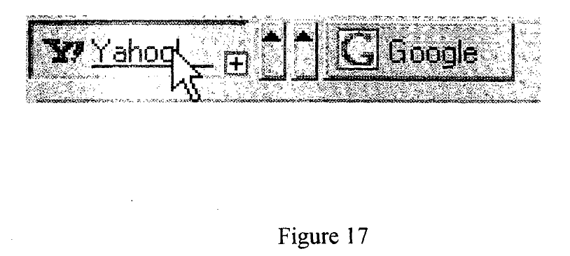

When children of a parent HTab are collapsed, labels and icons of the children are absent. Another mechanism is therefore required to display the hierarchical relationship of parent to children when the parent HTab receives focus from the mouse. In this situation in the preferred embodiment, small triangular icons on the collapsed children change from outlined triangles to a solid triangles. FIG. 16 shows the Yahoo HTab with 2 collapsed children. FIG. 17 shows the same HTabs with the Yahoo HTab receiving mouse focus.

The way that the browser interacts with the HTab GUI is critical to the functionality of the HTab. Browser parts that are needed are:

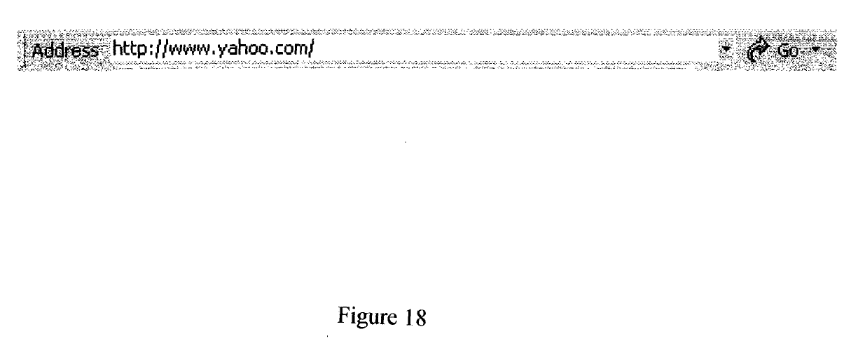

URL address bar: (FIG. 18) Location where a user 10 would type the URL of a web page in order to navigate to that page.

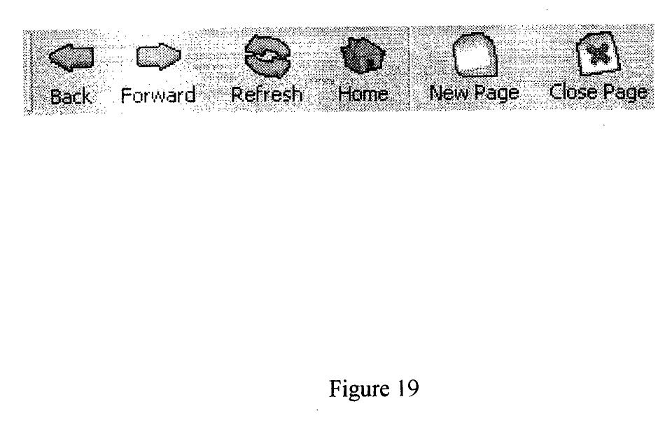

Navigation bar: (FIG. 19) Browser navigational buttons that also include buttons for creating a new page tab and closing an existing page.

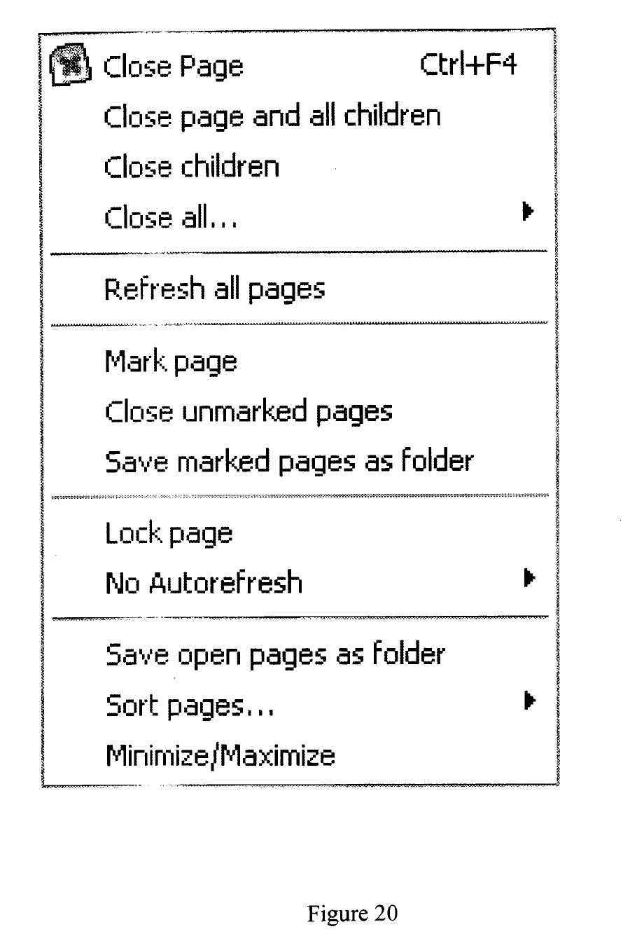

HTab context menu: (FIG. 20) The context menu is activated when the user 10 presses the right mouse button while the mouse cursor is over an HTab. The context menu is the main interface in the System 1 for performing functions on multiple HTabs. Using the context menu in conjunction with the hierarchical relationships inherent in the HTab, functionality can be attained that is not possible with existing browser interfaces. For example: An entire tree (parent, children, grandchildren, etc) can be saved as bookmarks with their hierarchical relationship preserved as bookmarks, folders, and subfolders.

Individual HTabs can be marked and saved as a group.

Pages that are not marked can be closed with one function.

All children of one parent can be closed in response to a single user input.

HTab Bookmark System—Web browser GUI bookmark system that (1) defines local browsing settings for each individual page within a tabbed-based browsing environment. (2) Allows hierarchical relationships that exist within an HTab GUI to be saved and loaded. (3) Allows common settings within a bookmark group to be edited collectively. (4) Provides workgroup sharing of bookmarks according to defined bookmark sharing rules within a networked computing environment. Netscape, being the first commercially accepted web browser, started the basic bookmark system used in most browsers. The structure is a standard tree interface with folders, sub folders and hyperlink bookmarks. Only minor innovation has occurred in this bookmark system. For example, a feature that notifies the user 10 when a web page has been updated, or a feature that adds visual separators into the bookmark tree. However, the basic structure of the bookmark system has not changed; they consist of a page title, hyperlink, description, and keywords.

Current bookmark systems do nothing to effect the individual settings of each page in a tabbed based browsing environment. The structure was carried over from single paged browsers and the settings that effect the browsing environment are stored globally in the application.

HTab's ability to display hierarchical relationships allows the System 1 to save and manage current-state hierarchical relationships. A current work state can persist through multiple program executions as well as being saved to a bookmark system capable of preserving hierarchies.

The System's 1 HTab bookmark system improves upon existing bookmark systems in 5 ways.

(1) The tree structure of the HTab bookmark can preserve the hierarchical relationships that exist within the HTab GUI. This is done by allowing each node within the bookmark tree to be a hyperlink and a parent node. In existing bookmark systems, only a folder can have a sub items. Hyperlinks are saved in folders and sub folders. Without the need to preserve hierarchical relationship, there was not a need for existing bookmark systems to pursue this innovation. The inability to treat hyperlink bookmarks as parent nodes prevents existing bookmarks systems from preserving the hierarchical relationships that exist between open web pages.

(2) In an HTab bookmark, information stored in the bookmark data structure effects individual page settings of URLs opened with the bookmark. In prior bookmark systems, this information is stored globally and all pages receive the same settings. HTab bookmarks contain individual page setting for treatment of graphics, multimedia, pop-up windows, auto-refresh, user permissions for network sharing, and automatic login settings.

(3) HTab bookmarks can be treated and edited as a group. While editing properties of an HTab bookmark group, all changes in display settings for the page propagate to members within the immediate bookmark group. For example, the user 10 can turn web page graphics off for an entire group at one time without having to change the settings on each bookmark individually.

(4) HTab bookmarks can be shared over a network such as a LAN or WAN. For each bookmark entry, the user 10 who created the bookmark is recorded. The user 10 who created the bookmark can flag the bookmark as public or private. If the bookmark is flagged as public, other users on the network can use the bookmark, but cannot delete or edit it. If the user 10 marks his bookmark as private, then only that user 10 can see the bookmark. Network ready bookmarks improve on prior art in the realm of security and workgroup efficiency. Security is increased because a manager can save bookmarks which are configured for HTab automatic login (Described in next section). The password for the site is never seen by the people in the workgroup, yet they can still use it to login. Workgroup efficiency is increased by being able to share bookmark resources across the enterprise.

(5) HTab bookmarks are integrated Smart Form Fill and Single Sign On (covered in next section).

Login Wizard—Process within a web browser that guides users 10 through the selection of fields within an HTML form. Selected fields are recorded and used to automate the submission of a web page form (via Smart Form Fill).

Smart Form Fill—Process of automatically filling in and submitting of an HTML form with a combination of previously defined static elements (recorded with Login Wizard) and fields who's dynamically generated values persist from the creation of the web page through the submission of the form.

Single Sign-On—Process of using Smart Form Fill to submit one or many HTML forms in response to a single user input. Most people who use the Internet on a regular basis access websites that require authorization to enter the site. The authorization usually comes in the form of a request for a username and password. Common sites that require login to gain authorization are free email services as well as subscription based services such as monster.com or hooversonline.com.

Recent versions of Internet Explorer have features that will remember a username and password for a given site; however, the functionality is severely limited. For example, some sites require more than just username and password. Several fields may need to be completed in order to access the site. Dice.com is a good example. For a recruiter to login, 2 logins are required in addition to a password. Another problem with the existing automatic login is that logins cannot be shared with other users, nor can they be saved. If the program is erased or the machine is updated, the login settings are lost.

The HTab auto-login is broken into three sub processes: Login Wizard—Process that teaches the System 1 which fields are needed to automatically submit an HTML form.

Smart Form Fill—Process of automatically completing an HTML form, with a combination of static values (stored previously) and dynamic values generated by a web server.

Single Sign On—Process of using Smart Form Fill to submit 1-N forms in response to a single user input.

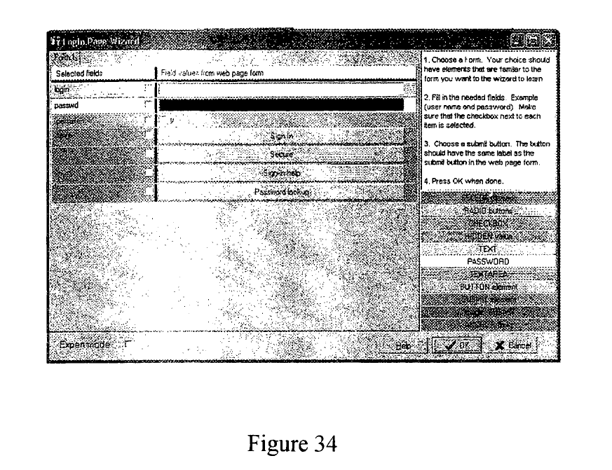

Login Wizard: The login wizard is started after a user 10 saves a hyperlink bookmark into the HTab bookmark system. The bookmarked page is the one that the user 10 wants to automatically login to. Yahoo mail is being used for this example. The first thing the login wizard does is reload a fresh copy of the bookmarked page. Next, a form is created that shows a representation of each web page form (FIG. 34). This structure is created by parsing the forms that exist within the HTML document and then representing them as related elements within the operating system GUI. For example, a web form checkbox is represented by an operating system checkbox component.

The definition of a web page form is the structure that exists between the HTML parameters of <FORM> and </FORM>. Each web page can have multiple forms and each form can have multiple field elements that exist within the form including text fields, list boxes, radio check lists, drop down lists, hidden fields, and FORM buttons such as submit and reset buttons. The login wizard displays each form and the elements of that form in its own tab. The tabs are labeled FORM1 . . . N. The elements for each web form are shown with default form field values next to them. Default form field values are set by the server that created the HTML form. A checkbox is present next to each form element under the column “selected fields”. Selection of the checkbox denotes choosing that field for inclusion in the automatic form filling operation.

A color coded field-type key is displayed in the bottom right of the login wizard. Each color represents a different type of field that can exist in an HTML form. Field types are HIDDEN, SELECT, RADIO, TEXTAREA, CHECKBOX, TEXT, PASSWORD, Button Element, Image SUBMIT, and ANCHOR link.

To complete the wizard process, the user 10 must perform the following steps. (1) Choose which fields are to be included in the automatic form filling operation. Typing a value in any of the fields automatically sets the “selected fields” checkbox to a checked state. (2) Select a submit button. The submit button will have the same label as the submit button the user 10 chooses to log into the web page in a standard fashion. (3) The user 10 presses the OK button and the login wizard process is complete.

Smart Form Fill: When the login page wizard is complete, the “Automatic login” property in the HTab bookmark is checked. This means that the only thing the user 10 has to do to login to a web site is double click on an HTab bookmark. The Smart Form Fill then takes the values the user 10 selected from in the Login Page Wizard and fills in the target form elements. Form variables that were not explicitly set in the Login Page Wizard retain their default values, therefore preserving any unique hidden form field values that are generated by the server, such as server session ID's. After filling in fields, Smart Form Fill then submits the form using the designated button chosen in the Login Page Wizard.

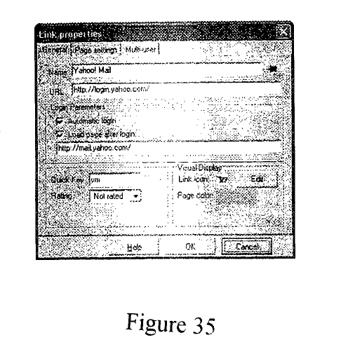

HTab bookmarks have additional fields that can come into use after the form has been submitted and the resulting page is loaded. The checkbox labeled “Load page after login” and the text field under it allows the navigation to an alternative destination page once the user 10 is logged into the target server. Properties of an HTab bookmark including “Load page after Login” are shown in FIG. 35. An example use of this would be to use Automatic login to login to a web mail account and then navigate directly to the check mail page.

It should be specifically noted that the Login Page Wizard/Smart Form fill can be used for very complex logins that require multiple fields with 10, 20, or even 100 field elements.

An advanced application of the Login Page Wizard/Smart Form Fill allows the chaining of several HTab bookmarks to achieve data mining ability. By chaining several HTab bookmarks together, web pages that require submissions of several sequential forms can easily be navigated to with a single user input.

Single Sign On: HTab bookmarks support folders. Each folder can have multiple bookmarks with login information in each one. The System 1 allows folders to be “launched” as a group. All items within a launched group will be opened in its own HTab. All rules that apply to opening a single bookmark will be followed during a group launch, including automatic login. Therefore, a Single Sign On to all of a user's password protected sites can be achieved with a single user input.

Launch Row Links/Launch Column Links in HTabs—Process of extracting HTML hyperlinks within a table row or column, each into its own child HTab.

Throughout the Internet, there are countless numbers of web pages that include information stored in HTML table structures. An HTML table is defined within the body of an HTML page, and is delimited starting with <TABLE> and </TABLE>. HTML tables can have any number of rows and column within them. HTML rows are defined by delimiters <TR> and </TR>. HTML columns are defined by delimiters <TD> and </TD>.

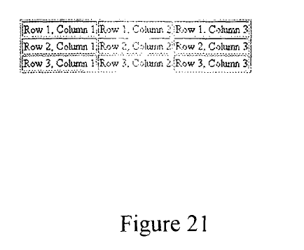

3×3 HTML table definition.

<table border=“1”><tr> <td>Row 1, Column 1</td> <td>Row 1, Column 2</td> <td>Row 1, Column 3</td> </tr> <tr> <td>Row 2, Column 1</td> <td>Row 2, Column 2</td> <td>Row 2, Column 3</td> </tr> <tr> <td>Row 3, Column 1</td> <td>Row 3, Column 2</td> <td>Row 3, Column 3</td> </tr></table>See FIG. 21 for an example of how the above table displays in a web browser.

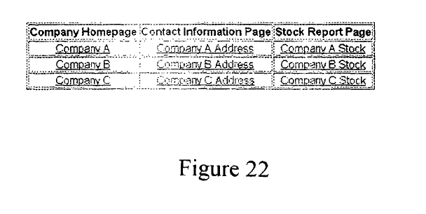

In the provided example table, much of the information is similar. However, in most real world cases, table data is highly differentiated. For example, examine the table in (FIG. 22). The first column has hyperlinks for company websites, the second column contains address information, and the third column contains hyperlinks to stock market reports. Currently, functions such as “open all links” exist in several commercially available web browsers. However, if a user 10 desired to follow only company website hyperlinks, a function that opened all links within the given web page would produce undesired results. The inability of these web browsers to target specific rows or columns within a table is a limitation.

The nature of the HTab promotes solving limitations such as the previous “open all links” example. The System 1 enables functions “Launch column links” and “Launch row links” to work in conjunction with the HTab. The HTab accommodates multiple open web pages and maintains the hierarchical relationship between the parent page (source links page) and the child pages.

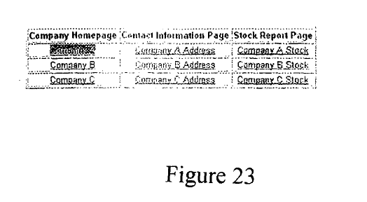

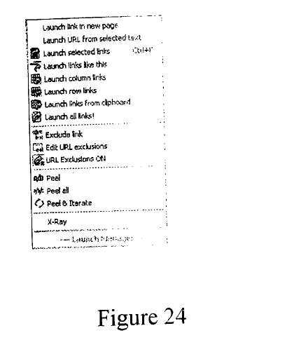

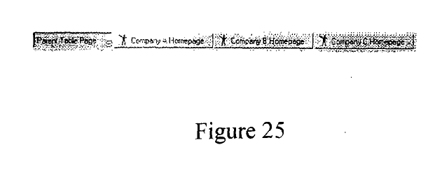

“Open all column links” function requires the user 10 to highlight any text within the target column within the HTML table. (FIG. 23). Once the text is highlighted, the user 10 presses the CTRL button on the keyboard at the same time as pressing the right mouse button. The result is the Launch Manager, shown in (FIG. 24). From the Launch Manager, the user 10 can choose either “Launch column links” or “Launch row links”. “Launch column links” and “Launch row links” work essentially the same whereas one works with vertical table elements and the other horizontal table elements. The results of choosing “Launch column links” after highlighting “Company A” in (FIG. 24) is shown in (FIG. 25).

Launch Links like this into HTabs—Process of extracting hyperlinks containing URL's similar to a user 10 supplied URL and placing each target hyperlink into its own child HTab. In addition to HTML table-centric operations, the Launch Manager has additional features, not found in prior art. The function “Launch links like this”(LLLT) works similar to the row and column launching functions; it is accessed via the Launch Manager (FIG. 24). Previously stated, prior art of “opening all links” is not a panacea for targeting specific links within an HTML page. In some cases, a hyperlink can redirect a web browser to “log out” the user 10. Subscription based Internet database services are an excellent candidate for LLLT. Results are returned in a series of hyperlinks and “logout” hyperlinks also exist on the same page. In addition, hyperlinks for different areas of the service as well as advertiser links are present on the same page as search results. Examine the three search result hyperlinks below. In this example, each URL represents a link, when followed, will show web pages with details on a specific company.

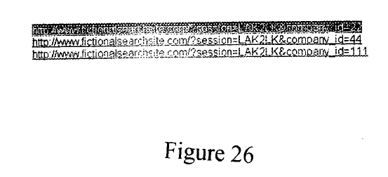

http://www.fictionalsearchsite.com/?session=LAK2LK&company_id=22 http://www.fictionalsearchsite.com/?session=LAK2LK&company_id=44 http://www.fictionalsearchsite.com/?session=LAK2LK&company_id=111 To use LLLT, the user 10 needs to highlight any of the result links in the browser window (FIG. 26). Next, the user 10 selects “Launch links like this” from the Launch Manager (FIG. 24).

LLLT works in the following way. First, all hyperlinks are extracted from the web page and saved into a list. Next, all links in the list are examined for a match to the exact substring from the selected hyperlink. If at least 2 values are found to match, then that substring is selected as the template substring. The template substring is then compared to all links in the saved list (up to the length of the template substring). All links that match the template are selected and opened in new HTabs. If the template substring does not match at least 2 links within the list, one character is stripped off the end of the original and the list is again examined for matches. The process of comparing and striping continues until the entire string length is exhausted or the desired 2 matches are found.

It should be noted that there are two additional variants in the LLLT process:(1) Changing the number of characters that are stripped off for each pass of the processing.

(2) Before processing the hyperlink list, stripping off the ends of all characters up to the first non alpha numeric character in each hyperlink.

(“ . . . site.com/?session=LAK2LK&company_id=111”becomes “ . . . site.com/?session=LAK2LK&company_id=”Both of these variants can be used to avoid situations such as 2 links ending in similar values (example: “id=22”and “id=222”). Without the variants in effect, all other similar pages would be skipped once the “22”and “222”were located.

URL X-Ray and load into HTabs—Process of testing for the existence of, and opening 2nd level domain names, each in its own child HTab, by cross referencing a user 10 supplied URL and a database of potential 2^{nd} level domain names. Many 2^{nd} level domain names exist that are not generally known. Within many of these 2^{nd} level domains is a wealth of information that is valuable to anyone doing research on a given company.

The existing methodology of testing for second level domains still rests in the realm of the keyboard; type a possibility into a browser address bar and see if the web page exists.

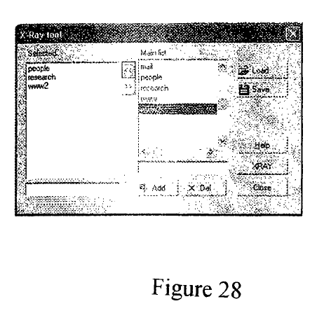

URL X-Ray is the process of testing for the existence of, and opening 2^{nd} level domain names, each in its own child HTab, by cross referencing a user 10 supplied URL and a database of potential 2^{nd} level domain names. The user 10 selects X-Ray from the Launch Manager. The X-Ray tool dialog box is opened. (FIG. 28). X-Ray works by testing for the existence of all 2^{nd} level domains combined with the 1^{st} domain name from the URL currently in the browser.

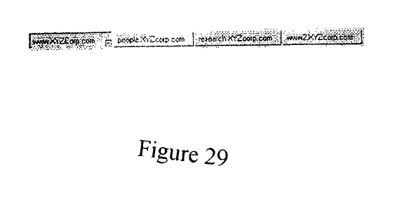

For example: if User 1 is X-raying the site www.XYZCorp.com, and User 10 move into the selected list: “people”, “research” and “www2”, XRAY will check for the existence of: www.XYZCorp.com people.XYZCorp.com research.XYZCorp.com Each existing URL is opened in its own child HTab. Assuming all of the 2^{nd} level domains that were tested in this example existed, the results would resemble (FIG. 29).

Peel & Iterate into HTabs—The process of iterating though all permutations of a URL (based on substituting a subsection of the URL with a range of values) and testing for the existence of the URL, and opening each existing URL into a child HTab given:

A user supplied URL with at least one numeric variable in the contents.

A user defined sub section of the URL which is replaced by each combination attempt.

A numeric start, stop, and optional step value (default=1) that define the range of values to be substituted for the selected SUB selection within the given URL.

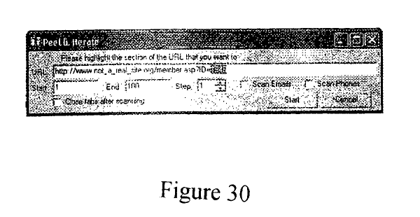

The Peel and Iterate dialog box (FIG. 30) shows the URL for a fictitious web site. Within the URL of that website is a numeric value of 1948. When the Peel and Iterate function is started from System 1, the current URL of the active web page is passed into the dialog. The first numeric value found in the URL string is highlighted automatically. The user 10 has the option to choose another number from the URL string. Next, the user 10 sets the start, stop, and step values. When the user 10 presses the start button the Peel and Iterate function will step through all values specified in the start, stop, and step values.

Start, Stop and Step values work much like the parameters in a “for” loop in the C++ language. In the C++ language, the “for” loop for the Peel and Iterate function would take the form: for( range=start; range<=end; range=range+step) “Range” is representative of the number that is substituted for the number “1948”in each iteration attempt.

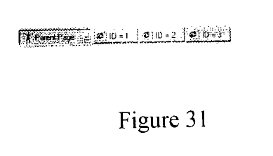

The example in FIG. 30 would test for the existence of a large number of pages. To simplify the output, FIG. 31 shows the sample HTab state if only the first 3 iterations resulted in pages that existed.

A variant of functionality of the Peel and Iterate is the extraction of data, such as email addresses from each result page.

System Command Line The HTab is a new construct for browsers. With that new construct comes additional ways in which a browser, such as the System 1, can interact with other applications within any given operating system. Email programs, chat programs, and news reader programs all interact with browsers. This is done by associating certain file types within the target operating system with the browser. For example, files that end in the extension of “HTM” and “HTML” are usually opened automatically by the default browser.

The problem with existing browsers is that when a new hyperlink is launched from another program, the current browser window is replaced with the recently launched hyperlink. As a result, important information could be lost. Tabbed browsers solve this problem by opening new hyperlinks into a newly created tab.

With the hierarchical structure inherently supported in the HTab, a more efficient interface for working with outside applications can be achieved. With the system's 1 command line interface, any program can interface with the HTab GUI. For example, assume the existence of a contact management program called “BigContact”. “BigContact” is able to create a new HTab within the System 1 with a unique label that is saved within the BigContact application. BigContact can then totally control all HTab nodes it creates; causing the creation or deletion of child nodes, closing of nodes, and activating and deactivating nodes. In addition, nodes created by “BigContact” will not affect nodes created by other applications and visa versa.

The System 1 has two settings that effect how external programs work with it. The first setting determines if a link opened from an outside program will be created in a new HTab or in the current HTab. The second setting determines if an external link will be created as an active HTab or an inactive HTab. Links opened from external programs will follow the default behavior specified by the System 1 internal settings unless they are explicitly overridden by command line parameters.

The system uses command line parameters NEW, CURRENT, ACTIVATE, DEACTIVATE, CHILD, PARENT_ID. System.exe refers to the file name of the system program. Sample command lines used by “BigContact” to control the system 1:

Open in new HTab:

system.exe http://www.yahoo.com-new

Open as current HTab:

system.exe http://www.yahoo.com-current

Open as activated HTab:

system.exe http://www.yahoo.com-activate

Open as deactivated HTab:

system.exe http://www.yahoo.com deactivate

Open as deactivated HTab, assign the HTab the ID of 10001 and make it a child HTab of the HTab with ID 10000

system.exe http://altavista.com-id=10001-parent_id=10000-deactivate

Open as activated HTab and make it a child of the currently active HTab

system.exe http://altavista.com-child-activate

P-HTML—With the advent of tabbed browsers, an extension to HTML is apropos. Currently HTML lacks support for issues dealing with multiple open web pages or the interaction of those pages.

Within the System 1, there are some extensions to the HTML language. This extension to HTML is called P-HTML for Paged-HTML. Unlike HTML, P-HTML has nothing to do with the layout of the page, but instead it contains logic pertaining to how multiple pages can interact. Currently the functions of P-HTML include page locking, page unlocking, page activation, event scheduling, and application flash.

Examples uses of P-HTML: Page Locking: Web conferencing systems start a web conference by loading a web page. If a user 10 inadvertently closes the page, the conference is ended prematurely. A P-HTML command allows the start page to be automatically locked by the conference vendor. The conference is then safe from being closed by mistake.

Scheduling: Scheduled events listed on a web page are directly inserted into the the System 1 event manager. The System 1 will automatically open up a new page and load the web page at the time of the event.

Page Activation: Scheduled events listed on a web page are directly inserted into the Systemmanager.B The System 1 ill automatically open up a new page and load the web page at the time of the event.

Application FFlash: UsingP-HTML, important parts of the application can immediately be brought to the users a10 attention. Insteadof using screen shots to show pieces of the application, the user 10 an click on a web link that flashes a part of Bthe System 1such as the navigation bar.

Data builder—Process of parsing and extracting data found within an HTML table and archiving extracted data into a database that may or may not have similarly organized database field definitions. BThe System 1 with the ability to organize information in a hierarchy becomes a powerful research tool. Information can be found and categorized faster than previous browsers. However, what does a user d10 o with the information once it is found? Data Builder is a function that allows the extraction of data found within an HTML table and copies it directly to an ODBC database. T

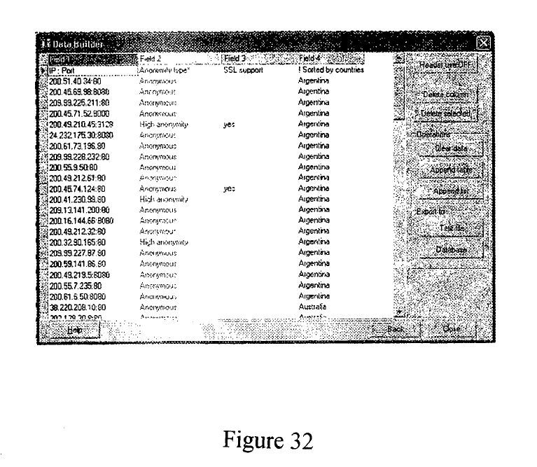

In the preferred embodiment, to use Data Builder within the System 1 the user 10 needs to follow these steps: (1) Highlight any text within the target table. (2) Press the SHIFT key at the same time as pressing the right mouse button key. (3) Follow the wizard steps starting with the Data Builder form. (FIG. 32). Within the Data Builder form, the user's task is to choose which columns to keep and which columns to delete from the captured data. Next, the user 10 chooses what to do with the data. Options are appending to an existing database or text file, or creating a database or text output.

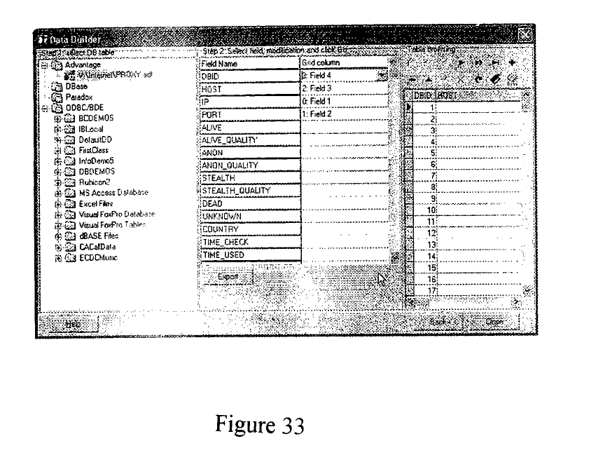

The next step is the Data Builder export form. (FIG. 33) In this step, the user (1) selects the database to export to and (2) Aligns the columns of captured data and fields in the destination database.

AdvantagesThe previously described version of the present invention has many advantages. The system is to develop a better method tfor browsing using a hierarchical structure and logic

Although the present invention has been described in considerable detail with reference to certain preferred versions thereof, other versions are possible. For example, the functionality and look of the wsystemcould ube different, ifferent or new protocols or an Intranet could be used. Therefore, the point and scope of the appended claims should not be limited to the description of the preferred versions contained herein.

That which is claimed:

1. An internet browser consisting of:
a browser that uses a hierarchical structure.

2. The browser according to claim 1:
in which said browser uses a graphical user interface to display, organize and mange hierarchically linked WebPages.

3. The browser according to claim 1:
in which said browser has child pages that have an optional icon

4. The browser according to claim 1:
in which said browser has a collapse state:

5. The browser according to claim 4:
in which said collapse state is done through a collective means.

6. The browser according to claim 4:
in which said collapse state is done through by pressing an icon on said browser screen.

7. The browser according to claim 4:
in which said collapse state will collapse all of the children of a parent.

8. The browser according to claim 1:
in which said browser displays WebPages in a child-parent relationship.

9. The browser according to claim 1:
in which has the ability to change to a horizontally collapsed state

10. The browser according to claim 4:
In which said browser will collapse on a double click of a mouse.

11 A process of browsing the Internet comprising the steps of:
using a hierarchical browser.

12. The process according to claim 11 which includes:
having said browser using a graphical user interface to display, organize and mange
hierarchically linked WebPages.

13. The process according to claim 11 which includes:
having said browser has child pages that have an optional icon

14. The process according to claim 11 which includes:
having said browser has a collapse state:

15. The process according to claim 11 which includes:
having said collapse state is done through a collective means.

16. The process according to claim 11 which includes:
having said collapse state is done through by pressing an icon on said browser screen.

17. The process according to claim 11 which includes:
having said collapse state will collapse all of the children of a parent.

18. The process according to claim 11 which includes:
having said browser displays WebPages in a child-parent relationship.

19. The process according to claim 11 which includes:
having has the ability to change to a horizontally collapsed state

20. The process according to claim 11 which includes:
having said browser will collapse on a double click of a mouse.
